(19) United States
(12) Patent Application Publication
(10) Pub. No.: US 2008/0061453 A1
(43) Pub. Date: Mar. 13, 2008

(54) Furnace Air Freshener and Vent Deodorizing System

(75) Inventor: Celestine D. Diaz, Adamstown, MD (US)

Correspondence Address: RAFAEL J. DIAZ, 5708 NOTTINGHAM PLACE, ADAMSTOWN, MD, 21710, US

(73) Assignee: Rafael J. Diaz, Adamstown, MD (US)

(21) Appl. No.: 11/531,264

(22) Filed: Sep. 12, 2006

(51) Int. Cl. B01F 3/04

(52) U.S. Cl. 261/26; 261/115; 261/DIG. 88

(57) ABSTRACT

An air freshener system comprising of an electronically controlled air freshener unit mounted inside of a furnace ventilation shaft which uses the automatic operation of the furnace fan in a forced-air furnace system to disperse deodorizing and air freshening agents into the ventilation system of a residence in order to quickly and efficiently distribute the said agents throughout the residence. This system will also sanitize the ventilation system while at the same time dispensing air freshener throughout the entire house within seconds thereby eliminating the need to buy separate room air fresheners now available in the market as well as reducing the need to call in a professional vent cleaner to sanitize the ventilation system.

### BACKGROUND OF THE INVENTION—FIELD OF INVENTION

This invention relates generally to an electro-mechanical device used for ventilation systems.

### BACKGROUND OF THE INVENTION

The air freshener unit to be described in this invention will provide a quick, cheap, and convenient way of completely air freshening the entire house or office building, regardless of its size, in a matter of seconds while at the same time providing a continuous vent sanitation cleansing that will greatly reduce or eliminate dust mites, air containments, etc. that normally exists in forced air ventilation systems. Air freshener units are well known in the art. There are many types of air freshener units that operate both mechanically and electronically. So far, however, all of the said units, with the exception of one, are typically designed for a single room and they only affect the air for that single room. One therefore would need to purchase several of these units in order to cover multiple rooms. These types of patents are described by U.S. Pat. No. 5,141,707 to Brite and U.S. Pat. No. 5,148,984 to Bryson Jr. The air freshener designed for a ventilation system described by Farris, U.S. Pat. No. 4,067,692 describes a device that attaches directly to an existing heating and air conditioning system without making any substantial changes to the basic system. However, this invention is limited to only being capable of handling solid type air fresheners and it cannot be used as a vent deodorizer. The air treatment device described by Murray in his patent application #20020197186 suggests a device that is primarily used for odor deodorizing the air only. No prior art exists that allows for the same air freshener unit to further be capable of sanitizing the house's ventilation system at the same time the unit is freshening the air while eliminating dangerous air-bourn bacteria. It is also well known in the art of vent cleaning systems whereby a vent cleaning company will typically come into your home and clean out your vents of debris, followed by a sanitation cleansing using a deodorizer agent and a device that forces the deodorizer agent through the vents (typically a large blower unit). This of course is not a cheap procedure and must be done by professionals. This invention will greatly reduce the need for having professionals come out to clean your ventilation system other than removing debris from your vents. This invention also will have the capability of being electronically controlled by the user to allow for manual operation or automatic operation. Furthermore, this unit will also be capable of automatically dispensing the deodorizer spray only when the furnace fan is operating by detecting the flow of air and only when the heating elements in the furnace are not active.

### BACKGROUND OF THE INVENTION—OBJECTS AND ADVANTAGES

Accordingly, several objects and advantages of this invention are:
(a) to provide a very quick, efficient, cheap, and non-intrusive way of air freshening an entire house, regardless of its size, in a matter of seconds,
(b) to provide a means saving someone a lot of money by providing a means of air freshening an entire house using one unit instead of having to buy multiple room air freshener units that are available today in the market,
(c) to provide a means of manual operation or automatic operation of the air freshener unit,
(d) to provide a means of automatically sanitizing the ventilation system while air freshening the air through the use of the proper sanitation agents used to kill air containments,
(e) to provide a means of rapidly dispensing the air freshener particles throughout the entire house within seconds by the use of the existing furnace and fan,
(f) to provide a means of automatically dispensing the deodorizer spray only when the furnace fan is operating through the use of a airflow detector.

Further objects and advantages will become evident in the ensuing description and drawings.

### SUMMARY

In summary, this invention describes an air freshener and vent sanitation system which allows for a quick, efficient, cheap, and non-intrusive way of air freshening an entire house, office building, apartment complex, etc., regardless of size, in a matter of seconds while simultaneously sanitizing the ventilation system, thereby saving the user a significant amount of money overall. Note that although the following description will be referencing a home, this invention applies to any type of unit that uses a forced-air ventilation system.

### DRAWINGS—FIGURES

FIG. 1 shows a side elevation view of a furnace/cooling system showing a sectional cutout of the furnace air shaft with the air freshener device mounted on the ventilation shaft.

In FIG. 2, a front, side, and top view of the air freshener unit is shown.

In FIG. 3, a cross sectional side view is shown of the furnace vent which houses the air freshener unit as well as a cross sectional view of the air freshener unit itself.

### DRAWINGS—REFERENCE NUMERALS

1—Air Freshener Unit

10—Spray Nozzle Dispenser

12—Ventilation Shaft

14—Deodorizer Agent

16—Airflow Detector Tube

18—Deodorizer Compartment holder

20—Return Air Duct

22—Blower Compartment

24—Supply Air Duct

26—Deodorizer Supply Channel

28—Deodorizer Compartment Service Door

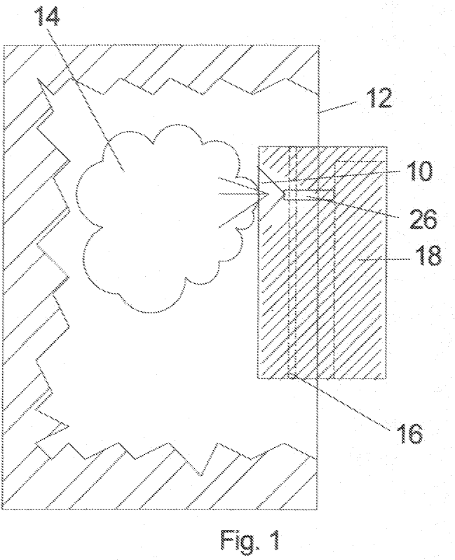

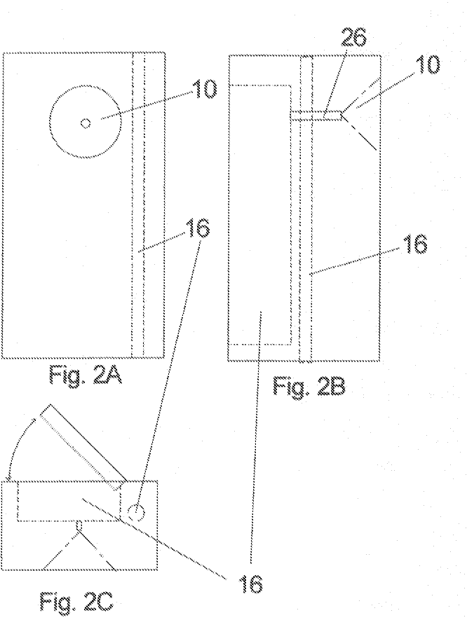

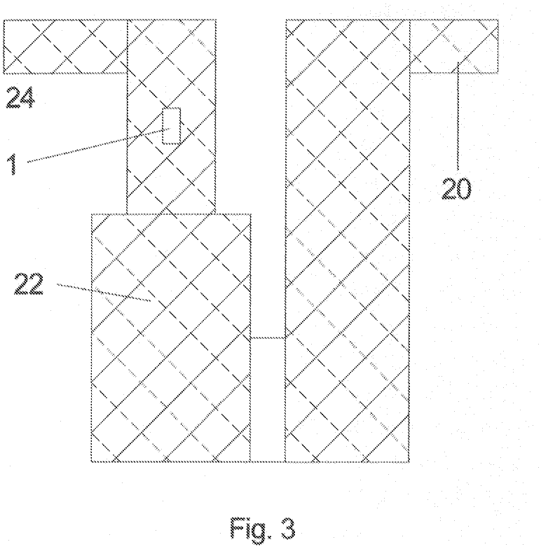

### DETAILED DESCRIPTION—FIGS. 1, 2, 3—PREFERRED EMBODIMENT

One embodiment of the whole house deodorizer and sanitation unit system is shown in FIGS. 1-3. FIG. 3 represents a typical forced air central heating/cooling system for a residential home. Forced heating/cooling systems for larger structures such as apartment complexes, high rises, and commercial buildings would be similar in concept. The unit consists of a return air duct 20, a blower compartment 22, a supply air duct 24 and the air freshener unit 1. The typical operation of the furnace is that the blower compartment 22 would draw air from the return air duct 20, and discharge it into the compartment which houses the heating and/or cooling elements, and then forces the heated/cooled air into the supply air duct 24 to be distributed throughout the rest of the residence.

In FIG. 1, a cross sectional side view is shown of the air freshener unit 1 attached to the inside of the furnace ventilation shaft 12. The ventilation shaft is shown as a cutout to show the air freshener unit mounted inside the ventilation shaft. The air freshener nozzle dispenser 10 is shown spraying the deodorizer agent 14 into the ventilation shaft 12. The furnace fan is used to disperse the deodorizer agent throughout the ventilation system and throughout the house. Not shown is the actual air freshener product in the form of a spray canister, which is inserted into the deodorizer compartment 18 with its spray nozzle connected to the deodorizer supply channel 26. The air freshener unit will only activate the canister's spray nozzle and dispense the deodorizer agent 14 into the ventilation shaft 12 via the deodorizer supply channel 26 when the furnace fan is activated. The activation device is not being disclosed as a part of this invention and has been left out of FIG. 1 for simplicity purposes. Those skilled in the art of forced-air furnace system know that the furnace fan operates on a periodic basis based on when the temperature of the house is different that the temperature set by the user. The airflow detector tube 16 within the air freshener unit serves as an easy, inexpensive, and non-intrusive way of detecting when the fan has been turn on by detecting the flow of air using a relatively simple electronic circuit. The airflow detector tube 16 is a small tube that extends throughout the entire length of the air freshener unit. The air freshener unit 1 has an easily assessable deodorizer compartment holder 18 which allow easy and quick assess to replenishing and servicing the air freshener unit. It also serves as a safety feature by mounting the air freshener canister on the outside of the ventilation shaft to prevent any possible chance of accidents due to the remote possibility of a malfunctioning heating unit that may cause the air inside of the ventilation shaft to exceed the recommended operating temperature of the air freshener canister unit.

### Operation—FIGS. 1-3

The furnace air freshener unit operates as follows. The air freshener unit 1 itself is a small, portable unit that can be easily attached to the inside of the furnace ventilation shaft 12 by the user or preferably by a professional installer who has worked with furnaces before. This invention does not preclude the method of installation however one can imagine the air freshener unit 1 being bolted to the side of the ventilation shaft 12 using a mounting housing (not shown), which would allow the air freshener unit 1 to be easily removed from the housing bracket for service or to replace the air freshener cartridge through the deodorizer compartment service door 28 shown in FIG. 2C. The air freshener system uses the operation of the furnace fan to disperse the deodorizer/air freshener agents throughout the residence. The normal operation of the furnace causes the fan to turn on in a forced-air furnace system to either distribute the heat or air conditioning throughout the residence. This air freshener system takes advantage of this for quickly distributing the deodorizing and/or air freshening agents to all rooms of the residence within seconds.

The basic operation of the unit then is to disperse the deodorizing agent 14 using the spray nozzle dispenser 10 of the air freshener unit 1 when, and only when the furnace fan is in operation and dispersing the heat/cold air throughout the residence. The unit can either be battery operated or it can use AC power. This invention does not specify the method used to power the unit. The actual spray canister nozzle is activated by an electro-mechanical device used to release the deodorizing agent 14 by means of an electrical signal which then causes the electro-mechanical device to exert pressure against the spray nozzle to release the agent through the deodorizer supply channel 26 for a per-determined amount of time. This invention does not specify or show the electro-mechanical device used to release the deodorizing agent from the spray canister for simplicity purposes however its operation is rather simple. Any type of electrically-activated spring loaded pivoting lever arm or a piston-like device an be used to exert downward pressure on the spray release nozzle of a standard spray canister housing the deodorizing agent. The supply channel 26 is connected to the canister's spray nozzle.

There are two methods of controlling when the spray canister nozzle is activated to discharge the deodorizing agent 14. The first method to be described is the manual method of activating the spray (and the preferred method) and the second method is an automatic means of discharging the agents without human intervention. Regardless of which method is used, the method of detecting the presence of airflow, that is, making sure the fan is operating and pushing air through the ventilation shaft, is the same.

In one embodiment of this invention, the method of when to dispense the deodorizing agent into the ventilation shaft can be completely manual. This may be highly desirable mainly because if the air freshener unit 1 were to dispense the deodorizing agent automatically every time the fan is turned on by the furnace, there could be too much used in short time period as well as causing the potential of having to replace the deodorizer cartridge too often. The manual operation is simply one or more mounted switches mounted throughout the residence where by one can activate the switch when the house required deodorizing or the air freshened. The airflow detection tube 16 will be required since the user may activate the air freshening device at the moment when the fan is not operating. In this case, the air freshener unit will activate as soon as the fan is activated.

There are many methods of detecting the presence of airflow and this invention does not preclude the use of any of these methods for detection however in one embodiment of the invention, one can imagine a miniature windmill-like device which can be mounted inside the air freshener unit 1. When the furnace fan is turned on, air begins to flow through the ventilation shaft and through the airflow detector tube 16. The flow of air through the airflow detector tube 16 pushes against each vane of the miniature windmill-like device located in the airflow detector tube 16 causing it to turn. As in the standard windmill, a device for converting mechanical energy into electrical energy is activated thereby causing an electrical current to flow. This electrical current will in turn activate the electronically controlled air freshener spray nozzle to dispense the spray for a predetermine time period. In the case of the manually operated spray nozzle, the spray nozzle will not be activated unless the unit has first detected that the user has activated the switch to dispense the deodorizer agent 14. One skilled in the arts of digital electronics can imagine a simple AND gate circuit which requires that both electrical inputs into the AND gate component have a presence of an electrical current before the gate allows electricity to flow to the output of the AND gate. Of course, the output of the AND gate would operate the spray nozzle electro-mechanical activation device itself. Further explanation of how the actual control circuitry of the nozzle is beyond the scope of this invention. A non-mechanical method of detecting the presence of airflow is by means of an ordinary incandescent lamp filament and a simple circuit using a comparator to measure the difference in temperature of the filament when air is flowing past it vs. when the air is stagnant. The comparator circuit would activate the spray nozzle activation device when the temperature of the filament decreases as a result of the air flowing.

Once the nozzle has been activated and the deodorizer/air freshener spray has been dispensed for a predetermined time, the furnace fan will proceed to disperse the agents 14 throughout the ventilation system and throughout the residence thereby deodorizing the actual ventilation shafts themselves through depositing the agents along the inside walls of the ventilation shafts as well as air freshening the entire house at the same time.

In another embodiment of the invention, the deodorizing agent 14 can be automatically dispersed by the air freshener unit. The unit would do so by detecting the presence of airflow. This operates exactly as previously described in the manual operation above. The only difference is that after detecting the presence of air, and electrical signal will be sent to the spray nozzle activation device to automatically dispense the agents into the ventilation shaft without user intervention. To prevent over-deodorizing the residence, an electronic scheduling system should be used to schedule the dispersement on a periodic basis as programmed by the user. It is beyond the scope of this invention to detail the inner workings of such a timing device.

### CONCLUSIONS, RAMIFICATIONS, AND SCOPE

Thus the reader can see that this air freshener system is a very convenient, efficient, and cost effective way to disperse an air freshener and/or deodorizing agent throughout the entire residence within seconds. It is also a cost savings for the user in that it can also sanitize your ventilation system by placing an appropriate sanitizing agent and air freshener agent mixture in the air freshener unit to allow for the unit to coat the insides of the ventilation shafts to help eliminate germs, bacteria, dust mites, etc. from the residence.

While the above description contains many specificities, these should not be construed as limitations on the scope of the invention, but rather as an exemplification of one preferred embodiment thereof. Other variations are possible. For example, the following are a few possible variations:
(a) Instead of mounting the air freshener unit inside the ventilation shaft, one can also mount it against the furnace's air filter.
(b) The user activated switch for activating the spray nozzle can also be activated wireless if so desired.
(c) There are many variations of how to detect the presence of airflow through the unit as mentioned before and his invention only mentioned two obvious methods however the airflow detection tube may be of a different design to accommodate alternate methods of airflow detection.
(d) Instead of using an airflow detection device to determine if the fan is operating, one can also directly wire the air freshener unit to the fan switch used by the furnace so that when the furnace switches the fan on, it also sends an electrical signal to the airflow detection device.

Accordingly, the scope of the invention should be determined not by the embodiment(s) illustrated, but by the appended claims and their legal equivalents.

1. A method of an air freshener and sanitation system which allows for an air freshener device to quickly and efficiently deodorize and dispense air freshener agents throughout the entire residence using the existing forced-air furnace system, comprising:
(a) a mountable air freshener unit with an electronically controlled spray nozzle,
(b) a method for detecting furnace fan operation thereby forcing air throughout the ventilation system,
(c) a means by which the said spray nozzle can be activated automatically,
(d) a means by which the said spray nozzle can be manually operated thereby overriding automatic operation,
(e) a means by which the said spray nozzle is activated for a pre-determined amount of time by the use of a timing device,
whereby the air freshener device can use the forced-air furnace system for dispensing the said deodorizing and air freshener agents by being mounted inside of the furnace ventilation shaft and activating the said spray nozzle when the said air flow detection device has detected the presence of flowing air through the activation of the furnace fan, resulting in the said deodorizing and air freshener agents being dispense rapidly throughout the residence while at the same time sanitizing the ventilation system thereby reducing the need for said ventilation shaft cleaning and purchasing multiple room-only air fresheners to accomplish the same task.

2. The method for detecting furnace fan operation of claim 1 wherein said fan operation detection is comprised of a device capable of converting wind energy into mechanical energy and finally into electrical energy used to electronically activate said spray nozzle.

3. The method for detecting furnace fan operation of claim 1 wherein said fan operation detection is comprised of a non-mechanical method of detecting the presence of airflow through the use of an electronic circuit and a temperature measuring device attached electronically to the said spray nozzle for controlling the activation of the said spray nozzle.

4. The method of manual operation of said spray nozzle of claim 1 wherein the user activates the said spray nozzle at anytime thereby causing said spray nozzle to activate during the next fan cycle.

5. The method of activating said spray nozzle for a pre-determined amount of time of claim 1 wherein an electronic or mechanical device timer is pre-programmed to a set amount of time for activating said spray nozzle and dispensing said air freshener agents.
